(19) United States
(12) Patent Application Publication
(10) Pub. No.: US 2008/0041482 A1
(43) Pub. Date: Feb. 21, 2008

(54) METAL TUBE ARRANGEMENT WITH INNER TUBE AND OUTER TUBE

(75) Inventors: Dietmar Baumhoff, Siegen (DE); Karl-Heinz Munker, Hilchenbach (DE); Frank Bender, Drolshagen (DE); Stefan Hauk, Hilchenbach (DE); Matthias Weiss, Hilchenbach (DE)

Correspondence Address: Henry M. Feierelsen;Henry M. Feieresen, LLC, Suite 4714, 350 Fifth Avenue, New york, NY, 10118, US

(73) Assignee: Westfalia Metallschlauchtechnik GmbH & Co. KG, Hilchenbach (DE)

(21) Appl. No.: 11/923,174

(22) Filed: Oct. 24, 2007

Related U.S. Application Data
(60) Provisional application No. 60/862,834, filed on Oct. 25, 2006.

(30) Foreign Application Priority Data
Oct. 7, 2005 (DE) 10 2005 048 479.4

(51) Int. Cl. F16L 11/00

(52) U.S. Cl. 138/121; 138/142; 138/134

(57) ABSTRACT

The invention relates to a metal tube arrangement (1) for exhaust pipes of motor vehicles, which typically includes an inner tube (10) with hook or interlock connection as well as a bellows-like an outer tube (20). The inner tube (10) and the outer tube (20) are hereby connected to one another at regular distances along their extension. In particular, they can be coupled to one another via a helically revolving roll seam weld (30). The outer tube (20) is preferably made of two layers from a wound metal strip (21).

### CROSS-REFERENCES TO RELATED APPLICATIONS

This application claims the benefit of prior filed U.S. provisional Application No. 60/862,834, filed Oct. 25, 2006, pursuant to 35 U.S.C. 119(e), the content of which is incorporated herein by reference in its entirety as if fully set forth herein.

### BACKGROUND OF THE INVENTION

The present invention relates, in general, to a metal tube arrangement, and more particularly to a metal tube arrangement which can be used as decoupling element for exhaust pipes of motor vehicles.

German Offenlegungsschrift DE 38 04 208 A1 discloses a metal tube arrangement having an inner tube and an outer tube which are held together at their ends. One of the tubes (e.g. the outer tube) is intended to provide gas tightness and the other tube is intended to provide exhaust conduction. Published European Patent Application EP 1 467 072 A1 discloses a metal tube arrangement having an unstable inner tube which is stabilized through direct or indirect contact with a bellows-like outer tube. German Offenlegungsschrift DE 198 20 863 A1 discloses a metal tube arrangement in which the inner tube and the outer tube are additionally interconnected at an intermediate point along their axial extension, e.g. by welding, in order to reduce contact noise. German Offenlegungsschrift, DE 199 13 562 A1 discloses a metal tube arrangement for exhaust pipes of motor vehicles with a wound inner tube of metal and a bellows-like outer tube of metal. The inner and outer tubes contact one another essentially over the entire axial length without being firmly connected to one another. French Pat. No. FR 2 805 592 B1 describes a fuel tube of plastics having an inner tube and an outer tube, with a corrugated tube being inserted in-between.

It would be desirable and advantageous to provide an improved metal tube arrangement to obviate prior art shortcomings.

### SUMMARY OF THE INVENTION

According to one aspect of the present invention, a metal tube arrangement, in particular for an exhaust pipe of a motor vehicle, includes an inner tube made of metal and having annularly or helically oriented surface corrugations, and an outer tube made of metal in surrounding relationship to the inner tube and having annular or helically oriented surface corrugations, wherein at least every fourth turn of a surface corrugation of the inner tube is connected in at least one point with the outer tube between beginning and end of the metal tube arrangement.

To ensure clarity, it is necessary to establish the definition of several important terms and expressions that will be used throughout this disclosure. The term “surface corrugation” relates to basically any deviation from a cylindrical surface configuration, such as a radial constriction or a radial bulge of the tube surface. Annular or ring-shaped surface corrugations close by definition after a turn about the surface while in helical surface corrugations beginning and end of the surface corrugation are axially offset by the pertaining pitch after each turn. The term “turn of a surface corrugation” relates to a full (360°) turn of an surface corrugation.

Suitably, each turn of the surface corrugations of the inner tube is connected with the outer tube in at least one point. The connections between outer tube and inner tube may be spotlike, but may also be linear or two-dimensional. Furthermore, there is no need to provide the distances between two neighboring connection sites of equal size throughout, i.e. for example in one zone every second turn of the surface corrugation and otherwise every turn of the surface corrugation of the inner tube may be connected to the outer tube.

A metal tube arrangement according to the invention enables the outer tube and the inner tube to stabilize each other along their entire length because of the interconnection at short distances. As a result, a close coupling of axial movements of inner tube and outer tube is realized. In contrast thereto, conventional double tube arrangements typically involve a firm connection only at the beginning and end of the entire arrangement and optionally in a further intermediate point while the tubes can move independently from one another radially and axially. As a result of the continuous connections between the tubes disturbing noise emission is significantly reduced.

According to another aspect of the present invention, a metal tube arrangement for an exhaust pipe of a motor vehicle includes an inner tube made of metal, and an outer tube made of metal in surrounding relationship to the inner tube, wherein the inner tube and the outer tube are substantially continuously connected with one another along helical lines.

According to another feature of the present invention, the inner tube and the outer tube may be made from a wound strip, with the continuous connection of inner tube and outer tube sealing the metal tube arrangement. Suitably, the outer tube and the inner tube are hereby wound at the same pitch. As a result,
the transition zones between neighboring turns of the inner tube are each overlapped by a turn of the outer tube and sealed as a consequence of this connection of the outer tube with these neighboring turns of the inner tube,
and/or the transition zones between neighboring turns of the outer tube are each overlapped by a turn of the inner tube and sealed as a consequence of this connection of the inner tube with these neighboring turns of the outer tube.

As a result of the continuous connection between inner tube and outer tube, the metal tube arrangement exhibits especially high stability. In addition, the inner tube and the outer tube can be manufactured as cost-efficient wound tubes and the entire metal tube arrangement may still be gastight in view of the helical connection.

According to yet another aspect of the present invention, a metal tube arrangement for an exhaust pipe of a motor vehicle includes an inner tube made of metal and an outer tube made of metal in surrounding relationship to the inner tube and at least spot-joined to the inner tube, wherein at least one of the inner tube and the outer tube are made of a wound strip having turns substantially continuously connected with one another along helical lines.

The inner tube and/or the outer tube can also be made in the form of a cost-efficient wound tube, while still being gastight as a result of the helical connection of its turns. Optionally, the helical connection of this tube may be realized in one working step jointly with the spot connection with the respectively other tube. For example, the windings of a wound outer tube can be sealingly connected by roll seam welding and spot connections between inner tube and outer tube can be implemented simultaneously in the same working step in the same device.

Each surface corrugation of the outer tube may, optionally, be connected with the inner tube. As an alternative, every other or in generally at least every n^{th} surface corrugation of the outer tube may be connected with the inner tube (wherein n≧2); in this case, this leaves still an axial flexibility of the outer tube between the connecting points.

According to another feature of the present invention, each turn of the surface corrugation of the inner tube may be connected in at least one point with the outer tube. A maximum stability is realized in this way.

There are numerous possibilities to implement the manner of connection between inner tube and outer tube. The inner tube and the outer tube may be connected to one another in a form-fitting manner and/or by a material-based joint. Examples of a material-based joint include soldering or gluing, in particular also thermal joining (welding). Laser welding as well as the roll seam welding are in particular preferred as welded joints.

According to another feature of the present invention, the inner tube and the outer tube may be essentially continuously connected to one another along helical surface corrugation turns of the inner tube or the outer tube. In this way, the stability is especially high and the presence of regions is prevented that could cause rattling contacts between inner tube and outer tube. Further, gas tightness is positively realized by the use of wound tubes with continuous seams.

The inner tube may be made in particular from a wound metal strip. This metal strip may hereby be connected by way of a hook or interlock fit, as disclosed in German Pat. No. DE 101 13 182 C2, for example. The fit of the inner tube can be configured relatively loosely because the connections with the outer tube stabilize this tube.

According to another feature of the present invention, the outer tube may have bellows-like surface corrugations, i.e. a wavy structure in axial section with great distances between wave valleys and wave crests. The stated distances are typically greater by a multiple than the wall thickness of the outer tube and typically amount to about 5% to 100% of the inner diameter of the outer tube. As a result of the bellows-like structure, the outer tube exhibits superior axial and lateral flexibility so as to be able to track e.g. the mobility of a longitudinally changing inner tube.

According to another feature of the present invention, the outer tube can be constructed substantially gastight so that the entire metal tube arrangement is gastight and thus especially suitable for the use in exhaust pipes of motor vehicles.

According to another feature of the present invention, the outer tube may be made from a wound metal strip. This metal strip may be wound at least in two layers to attain a respective increase in stability and gas tightness of the outer tube.

Overall, a metal tube arrangement according to the invention exhibits superior stability and superior vibration properties.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic section through a wall portion of a metal tube arrangement according to the present invention; and

FIG. 2 is a detailed cutaway view, on an enlarged scale, of the metal tube arrangement, depicting a connection zone between inner and outer tubes.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

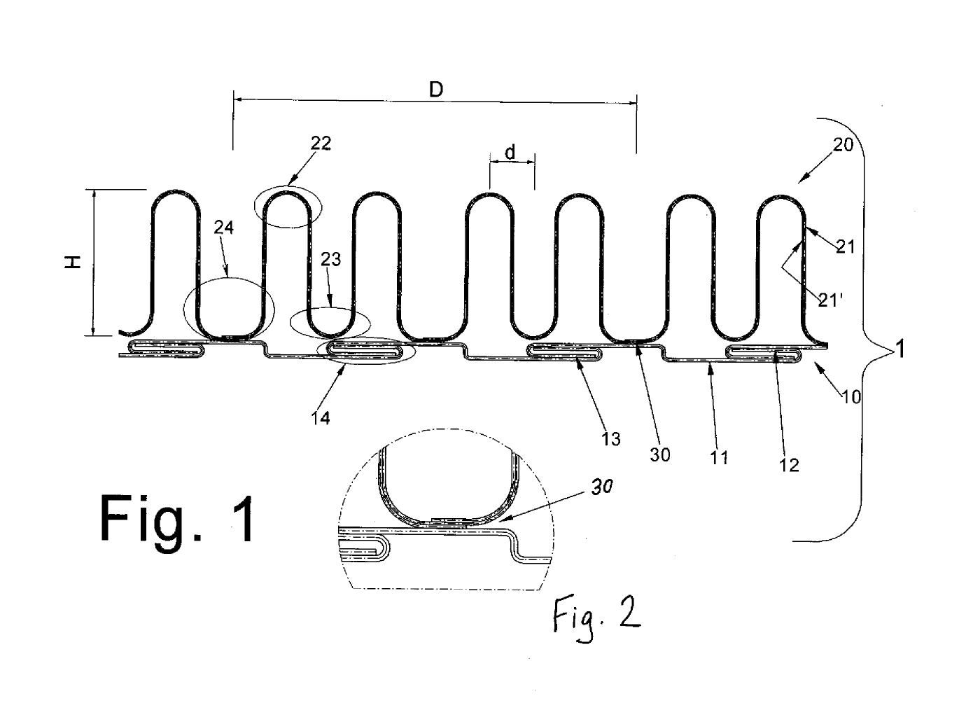

Turning now to the drawing, and in particular to FIG. 1, there is shown a schematic section through a wall portion of a metal tube arrangement according to the present invention, generally designated by reference numeral 1. The metal tube arrangement 1 includes an inner tube 10 and an outer tube 20 and may be part of a decoupling element, as used for example in exhaust pipes of motor vehicles. Such decoupling elements should be sufficiently flexible in axial and radial directions, on one hand, and gastight, on the other hand, in order to prevent escape of exhausts. In particular, when tubes are used that are wound from (profiled) metal strips, care should also be taken that the tubes are sufficiently stable in shape. The metal tube arrangement 1 may be made in particular of special steel, preferably of grades 1.4301, 1.4828, 1.4571, 1.4511, 1.4512, 1.4724, 1.4509, 1.4006, 1.4021, and/or 1.4122.

The metal tube arrangement 1 satisfies the afore-specified requirements by the combination of a wound inner tube 10 with a wound outer tube 20. The outer tube 20 is hereby made of a bellows-like profiled metal strip 21 having turns which extend over the axial distance D and include along this width four surface corrugations. The metal strip 21 is helically wound with a pitch of D/2 such that a following turn overlaps half of the preceding turn 21′ in axial direction. In this way, the illustrated two-layer bellows-like geometry is realized, with wave crests 22 following wave valleys 23, 24 at an axial distance d of typically 2 to 10 mm. Currently preferred is also a radial thickness H of the bellows of preferably 6 to 16 mm.

The inner tube 10 is realized by a tube which is wound from a profiled metal strip 11 with a pitch D/2 and formed with interlock fit. The right-hand end 12 of the metal strip 11 is bent back radially outwards and hooks into the other left-hand end 13 which is radially bent back inwardly. In this way, a metal tube 10 is produced which can be stretched or compressed in axial direction, with FIG. 1 depicting the maximally stretched configuration.

A feature of the metal tube arrangement 1 is the continuous interconnection at regular distances between the inner tube 10 and the outer tube 20 along their axial extension. In the illustrated example, a welded joint is hereby provided between every surface corrugation 12 of the inner tube 10 and every other surface corrugation 24 of the, outer tube 20. As a result of the double-layer winding of the outer tube 20, every turn of the outer metal strip 21 is thus connected with every turn of the inner metal strip 11. The associated welding spots 30, shown in particular in FIG. 2, are provided on the contact point between a wave valley 24 of the outer tube 20 and a radially outer transition zone 14 of the inner tube 10.

The joint 30 can be implemented through roll seam welding and runs continuously in the form of an encircling helix along the entire metal tube arrangement 1. Roll seam welding involves the placement of the surfaces to be welded between two drums that roll off thereupon, with current pulses being sent through the drums in short sequence to thereby produce a virtually continuous chain of welding spots through resistance welding. Through a continuously oriented weld seam, wound tubes that still have residual leaks can be transformed into a positively gastight metal tube arrangement 1. This is attained in the illustrated example by overlapping the transition zone 14 between neighboring turns of the inner tube 20 with at least one turn of the outer tube 20 and sealing the transition zone 14 as a result of being welded to both adjacent turns of the inner tube 10. The roles of inner tube and outer tube may, of course, be reversed, i.e. turns of the inner tube seal transition zones between turns of the outer tube. Moreover, such a sealing principle is also applicable in smooth (non-corrugated) wound tubes. Furthermore, the turns of only one of the tubes, e.g. the outer tube 20, may also be connected continuously helically and gastight, while the connection with the other tube, e.g. inner tube, is only spotlike.

End, middle, and beginning of a preceding actual and following turn of the metal strip 21 meet in the wave valley 24 of the outer tube 20 so that the outer tube 20 has three layers in this narrow region. Roll seam welding thus advantageously not only joins outer tube and inner tube with one another but also the mentioned three layers of the outer tube 20.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A metal tube arrangement, in particular for an exhaust pipe of a motor vehicle, said metal tube arrangement comprising:
an inner tube made of metal and having annularly or helically oriented surface corrugations; and
an outer tube made of metal in surrounding relationship to the inner tube and having annular or helically oriented surface corrugations,
wherein at least every fourth turn of a surface corrugation of the inner tube is connected in at least one point with the outer tube between beginning and end of the metal tube arrangement.

2. The metal tube arrangement of claim 1, wherein at least every nth surface corrugation of the outer tube is connected to the inner tube, wherein n>2.

3. The metal tube arrangement of claim 1, wherein the inner tube and the outer tube are connected to one another in a form-fitting manner.

4. The metal tube arrangement of claim 1, wherein the inner tube and the outer tube are connected to one another by a material-based joint selected from the group consisting of seam welding and laser welding.

5. The metal tube arrangement of claim 1, wherein the inner tube and the outer tube are substantially continuously connected to one another along helical surface corrugation turns of the inner tube or the outer tube.

6. The metal tube arrangement of claim 1, wherein the inner tube is made from a wound and profiled metal strip.

7. The metal tube arrangement of claim 6, wherein the metal strip has a hook or interlock fit.

8. The metal tube arrangement of claim 1, wherein the outer tube has bellows-like surface corrugations.

9. The metal tube arrangement of claim 1, wherein the outer tube is made from a metal strip.

10. A metal tube arrangement for an exhaust pipe of a motor vehicle, comprising:
an inner tube made of metal; and
an outer tube made of metal in surrounding relationship to the inner tube,
wherein the inner tube and the outer tube are substantially continuously connected with one another along helical lines.

11. The metal tube arrangement of claim 10, wherein the inner tube and the outer tube are each made from a wound strip, with the continuous connection of inner tube and outer tube capable to seal the metal tube arrangement.

12. The metal tube arrangement of claim 10, wherein the inner tube and the outer tube are connected to one another in a form-fitting manner.

13. The metal tube arrangement of claim 10, wherein the inner tube and the outer tube are connected to one another by a material-based joint selected from the group consisting of seam welding and laser welding.

14. The metal tube arrangement of claim 10, wherein the inner tube and the outer tube are substantially continuously connected to one another along helical surface corrugation turns of the inner tube or the outer tube.

15. The metal tube arrangement of claim 10 wherein the inner tube is made from a wound and profiled metal strip.

16. The metal tube arrangement of claim 10, wherein the metal strip has a hook or interlock fit.

17. The metal tube arrangement of claim 10, wherein the outer tube is gastight.

18. The metal tube arrangement of claim 10, wherein the outer tube is made from a metal strip wound at least of two layers.

19. A metal tube arrangement for an exhaust pipe of a motor vehicle, comprising:
an inner tube made of metal; and
an outer tube made of metal in surrounding relationship to the inner tube and at least spot-joined to the inner tube,
wherein at least one of the inner tube and the outer tube are made of a wound strip having turns substantially continuously connected with one another along helical lines.

20. The metal tube arrangement of claim 19, wherein the inner tube and the outer tube are connected to one another in a form-fitting manner.

21. The metal tube arrangement of claim 19, wherein the inner tube and the outer tube are connected to one another by a material-based joint selected from the group consisting of seam welding and laser welding.

22. The metal tube arrangement of claim 19, wherein the inner tube and the outer tube are substantially continuously connected to one another along helical surface corrugation turns of the inner tube or the outer tube.

23. The metal tube arrangement of claim 19, wherein the inner tube is made from a wound and profiled metal strip that has a hook or interlock fit.

24. The metal tube arrangement of claim 19, wherein the outer tube is gastight.

25. The metal tube arrangement of claim 19, wherein the outer tube is made from a metal strip wound at least of two layers.
